(19) United States
(12) Patent Application Publication
(10) Pub. No.: US 2020/0001858 A1
(43) Pub. Date: Jan. 2, 2020

(54) Range Extender

(71) Applicant: Tevva Motors Limited, Chelmsford (GB)

(72) Inventors: Asher Bennett, Brentwood (GB); Richard Lidstone-Scott, Chelmsford (GB); David Hampton, Chelmsford (GB); Tomasz Kusmierz, Chelmsford (GB)

(21) Appl. No.: 16/489,210

(22) PCT Filed: Feb. 28, 2018
(86) PCT No.: PCT/GB2018/050520

§ 371 Date: Aug. 27, 2019

(30) Foreign Application Priority Data
Feb. 28, 2017 (GB) 1703236.8

(51) Int. Cl. B60W 20/00; B60L 50/15; B60K 6/28; B60W 10/06; B60W 10/08; F02D 29/06; F02B 63/04

(52) U.S. Cl. CPC B60W 20/00; B60L 50/15; B60K 6/28; B60W 10/06; B60W 10/08; B60Y 2200/92; F02B 63/04; B60W 2710/0616; B60W 2710/08; B60Y 2200/91; F02D 29/06

(57) ABSTRACT

A range extender for a vehicle, comprises an electric machine; an engine; and a controller, wherein the controller is configured to control fuelling of the engine, and is configured to control the electric machine to charge a battery of the vehicle using power from the engine and at other times to control the electric machine to drive the engine using power from the battery, wherein the controller is configured to increase the engine speed by controlling the electric machine to drive the engine using power from the battery whilst substantially not fuelling the engine.

### TECHNICAL FIELD

This invention relates to an apparatus and method for controlling a range extender of an electric vehicle, and to associated vehicles and systems.

### BACKGROUND

Electric vehicles take a variety of forms, namely pure electric (where the only source of power is a battery), parallel hybrid (where an internal combustion engine or battery may drive the wheels), or series hybrid vehicles where a secondary power source re-charges an on-board battery (a range extender). The present invention is primarily concerned with the latter.

An exemplary approach for operating vehicles with a ‘dual fuel’ range extending functionality is to operate the vehicle purely as an electric vehicle until a predetermined level of charge is reached, at which point the range extender is switched on—and will remain on—until an upper state of charge (SOC) level is reached.

The range extender (RE) may be switched on at full power when the SOC reaches the lower threshold; charge is then increased until the upper threshold is reached. The ‘on time’ of the range extender is indicated by ‘RE State’ 1 being fully on, and 0 being off. This is sometimes referred to as charge depleting mode and a charge sustaining mode.

The range extender may have further operational modes, such as a high efficiency mode, where the secondary power source runs at a particular rpm for each mode.

SUMMARY OF INVENTION

According to one aspect of the present invention there is provided a range extender for a vehicle, including an electric machine; an engine; and a controller, wherein the controller is configured to control fuelling of the engine, and is configured to control the electric machine to charge a battery of the vehicle using power from the engine and at other times to control the electric machine to drive the engine using power from the battery, wherein the controller is configured to increase the engine speed by controlling the electric machine to drive the engine using power from the battery whilst substantially not fuelling the engine.

The controller may be configured to control the electric machine to drive the engine to increase the engine speed to an operational point set by the controller.

The controller may be configured to begin fuelling the engine when the operational point is reached.

The controller may be configured to fuel the engine at a constant fuel injection rate at the operational point.

The controller may control the electric machine charge the battery of the vehicle at the operational point, using power from the engine.

The controller may be configured to set an operational point out selected from two or more stored operational points.

The two or more operational points may correspond at least to a high efficiency mode and a high power mode.

The controller may be configured to increase the engine speed from a first operational point set by the controller to a second operational point set by the controller by controlling the electric machine to drive the engine using power from the battery whilst substantially not fuelling the engine.

According to another aspect of the present invention, there is provided a vehicle including an electric motor arrange to propel the vehicle; a battery for providing power to the electric motor; and a range extender according to the present invention.

The electric machine of the range extender may be controlled by the controller of the range extender to provide power to the electric motor.

Any feature in one aspect of the invention may be applied to other aspects of the invention, in any appropriate combination. In particular, method aspects may be applied to apparatus aspects, and vice versa. The invention also provides a computer program and a computer program product comprising software code adapted, when executed on a data processing apparatus, to perform any of the methods described herein, including any or all of their component steps.

The invention also provides a computer program and a computer program product comprising software code which, when executed on a data processing apparatus, comprises any of the apparatus features described herein.

The invention also provides a computer program and a computer program product having an operating system which supports a computer program for carrying out any of the methods described herein and/or for embodying any of the apparatus features described herein. The invention also provides a computer readable medium having stored thereon the computer program as aforesaid.

The invention also provides a signal carrying the computer program as aforesaid, and a method of transmitting such a signal.

Furthermore, features implemented in hardware may be implemented in software, and vice versa. Any reference to software and hardware features herein should be construed accordingly. Any apparatus feature as described herein may also be provided as a method feature, and vice versa. As used herein, means plus function features may be expressed alternatively in terms of their corresponding structure, such as a suitably programmed processor and associated memory. It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

The invention extends to methods and/or apparatus substantially as herein described with reference to the accompanying drawings.

### BRIEF DESCRIPTION OF DRAWINGS

Purely by way of example, the present invention is now described with reference to the accompanying drawings in which:

FIG. 1 is a schematic diagram of a range-extended electric vehicle;

FIG. 2 is a schematic diagram of a range extender according to an embodiment;

FIG. 3 is a schematic circuit-diagram of a controller for controlling the operation of the range extender;

FIG. 4 is a range-extender management graph;

FIG. 5 is a graph showing the operation of an internal combustion engine in a conventional range extender;

FIG. 6 is a graph showing the operation of the generator in a range extender according to an embodiment; and

FIG. 7 is a graph showing the operation of an internal combustion engine in a range extender according to the embodiment.

### DETAILED DESCRIPTION

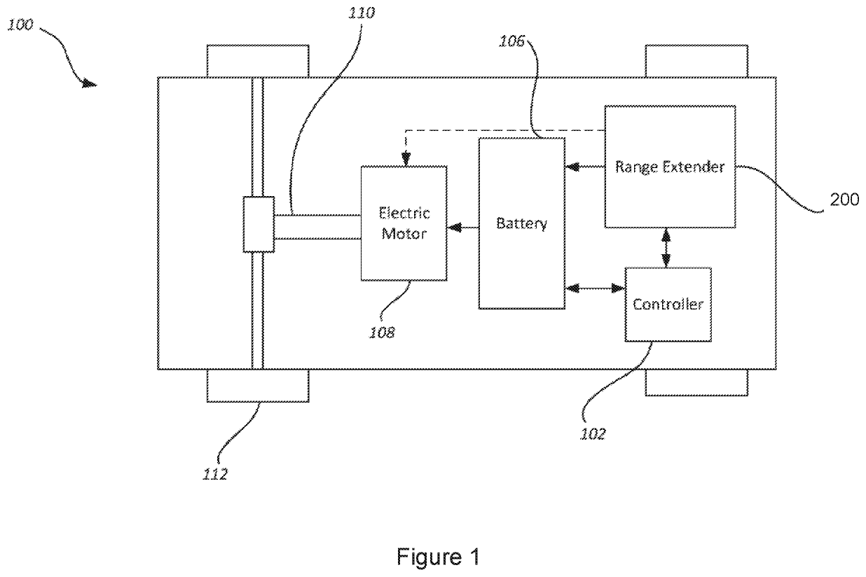

A range extended electric vehicle 100 is shown schematically in FIG. 1. The vehicle includes an apparatus for activating a range extender 200 within the electric vehicle 100, in the form of a controller 102 connected to and in communication with the range extender 200 and a battery 106, typically in the form of a battery pack. The battery 106 supplies power to an electric motor 108, which drives the wheels 112 via a transmission means such as a drive-shaft 110.

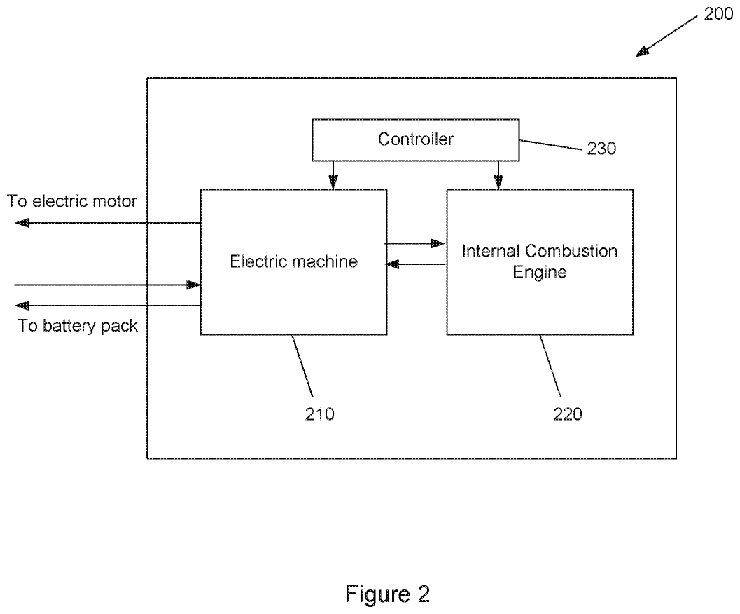

With respect to FIG. 2, the range extender 200 according to an embodiment is shown. The range extender 200 comprises an engine 220 connected to an electric machine 210 and a controller 230. The engine 220 provides a secondary source of power by burning a source of fuel. The engine 220 may be, for example, an internal combustion engine or a turbine engine, and runs on any suitable source of fuel e.g. petrol, diesel, liquid petroleum gas, propane, kerosene, biofuel etc.

The range extender 200 is connected to the battery 106 so as to re-charge it via the electric machine 210 (the circuitry necessary for this has been omitted from the drawing for clarity). In certain circumstances, the range extender 200 (via the electric machine) may also directly power the electric motor 108.

The electric machine 210 may be operated as generator to provide power to the battery 106 and may also be operated as an electric motor by supplying power from the battery 106. Any electric motor or generator may be referred to as an electric machine or, alternatively, as an e-machine, e-motor or e-drive.

The components of the range extender 200 are controlled according to the operation of the controller 230. In particular, the operation of the electric machine 210 and the fuelling of the engine 220 are controlled by the controller 230. Alternatively, the range extender 200 may be controlled directly by the controller 102. The controller 230, which is part of the range extender arrangement, may be connected to control other parts of the electric vehicle including the battery 106.

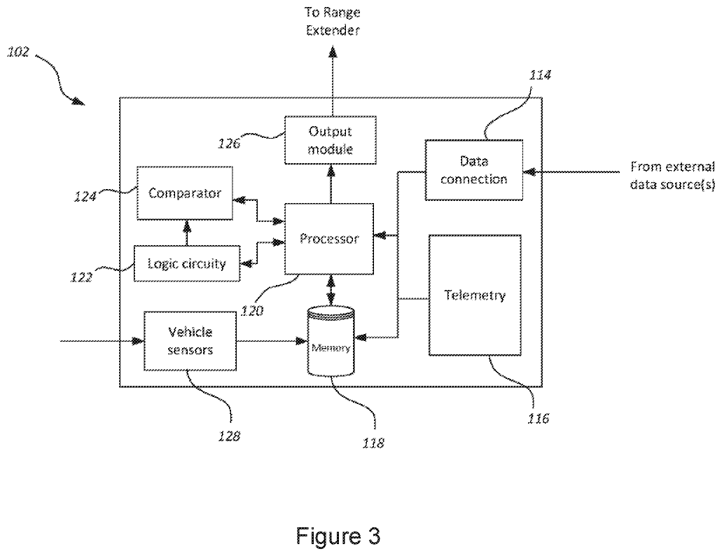

FIG. 3 shows a schematic representation of the controller 102 capable of controlling the range extender 200 to follow a particular power usage plan (or predictive model). Such a plan may include an activation schedule for the range extender 200 which is stored in a memory 118, so as to follow the desired plan. The controller 102 comprises a data connection 114 for receiving/retrieving data (such as trip itinerary information and power usage information) from external sources. This may be a physical connection, such as a Universal Serial Bus (USB) connection, or a wireless connection, such as General Packet Radio Service (GPRS), Global System for Mobile Communications (GSM), Universal Terrestrial Radio Access Network (UTRAN), Evolved UTRAN (E-UTRAN), Code Division Multiple Access (CDMA), Long Term Evolution (LTE), Worldwide Interoperability for Microwave Access (WiMax), or Bluetooth®. The controller 102 further comprises a telemetry unit 116. This unit includes a package of sensory or measurement instruments operable to sense or detect and record various parameters relating to the vehicle and journey (further trip information). Examples of such instruments include: a Global Positioning System (GPS), accelerometer, temperature/weather sensors, motor monitoring devices, and devices that monitor power usage/battery health.

The data from these various instruments is stored in the local memory 118 with the aid of processor 118. Local memory 118 also comprises information relating to previous trips, such as power usage information from previous trips and/or activation schedules relating to previous trips. This information may have been imported to the controller 102 from an external source, determined from telemetric data based on a previous trip, or a combination thereof, and is used when determining whether or not to activate the range extender 200 (i.e. in determining a power usage plan for a current trip). Such a power usage plan may be determined by processing data retrieved (from local memory or from an external source) on-board, or the processing of the data may be performed remotely (for example in the ‘cloud’) and transmitted to the device memory 118 via data connection 114. Logic circuitry 122 and comparator circuitry 124, with the aid of processor 120, determine if the conditions for activation of the range extender 200 are met, and if so, the processor 120 sends a signal to the range extender 200 via output module 126.

The controller 102 further comprises vehicle parameter sensors 128, which monitor parameters such as: the level of charge of the battery, battery state of health (Battery Management System) and motor speed. Such sensors may be connected to a bus (for example a CANbus (Controller Area Network bus) to allow communication between them and the controller 102). This information is stored in memory 118 and is used when determining whether or not to activate the range extender 200. The controller 102 may further comprise user interface components such as a display screen and/or keypad for users to manually input data (for example, to identify the driver); these are not shown for clarity, and would typically be wirelessly connectable to the controller 102 and implemented in a separate computing device such as a smartphone or tablet. Alternatively or additionally, an application may be provided on a separate user device (such as a smartphone or tablet device) to record/receive data to be used by the controller.

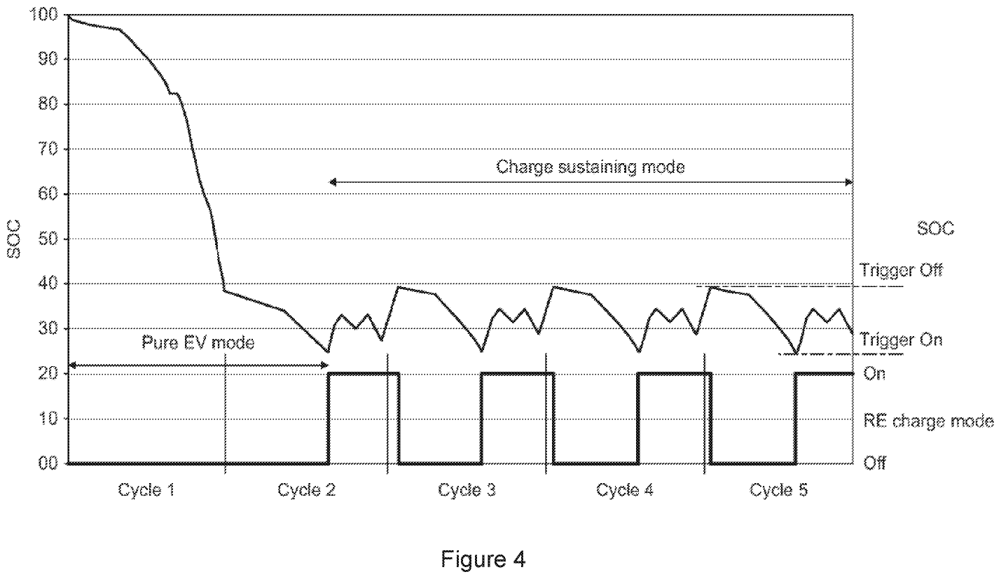

FIG. 4 is an exemplary chart to show the state of charge vs. time for a 5 cycle discharge test spanning a day's usage using an exemplary range extender model, and will be used as a reference and example in this detailed description.

Without any range extender input the graph (SOC) decays at a ratio of 1:1.73. With approximately 30 kW provided by an exemplary range extender the SOC is increased, on average, at a ratio of 1:9.

The nature of the range extender 200 is that it will produce power under full load. The electric machine 210 provides a full power load for the internal combustion engine 220, the power from the electric machine 210 being used either to charge the pack or assist with supply to the electric motor. The range extender 200 is held at a pre-set engine speed, or rpm (revolutions per minute) by the controller 230, dependant on an operational mode set by the controller 230. The operational mode is one of, for example, a high power mode, a high efficiency mode or a low power mode. This means the range extender 200 needs only to be mapped at a set rpm (while the electric machine load may change). The advantage of this is that fuel mapping is much simpler to develop and part load values are not critical, this saves development time and cost.

The exemplary range extender may include a 55 kW engine, which produces the required 30 kW in a high power mode with an engine speed of approximately 2500 rpm. The range engine may also be operated in a high efficiency mode, which produces 26.7 kW at a high efficiency, with an engine speed of approximately 1500 rpm. This averages out as the same as the discharge cycle rate (being equal to 30×8/9). As a result, the graph will flatten (i.e. stay at a constant charge) when the range extender 200 is in the high efficiency mode. The range extender may include a further low power mode, wherein the engine speed is set at approximately 1000 rpm in order to run more quietly, and only 24 kW is produced.

The range extender 200 is turned on in the high efficiency mode if pack SOC is below the target level. If the pack SOC is much less than the target level, then the range extender 200 may be switched to the high power mode. The level at which the SOC is determined to be less than (<) the target is a parameter that can be set depending on the particular implementation, in one example, this is a level 5% lower (e.g. SOC is 75% when the target is 80%), Similarly, the level at which the SOC is determined to be much less than («) the target is also a parameter that can be set depending on the particular implementation, in one example, this is 10% lower (e.g. SOC is 70% when the target is 80%), If the pack SOC is greater than (>) the target level, then the range extender 200 is switched off.

The range extender 200 may be used in the low power mode, or low noise mode, when the vehicle is travelling at low speeds as at such times the noise of the range extender 200 is most noticeable. Low speeds may be defined less than 30 miles per hour, more preferably less than 20 miles per hour. The range extender 200 may be turned on at high power when a high current threshold has been exceeded (to relieve/de-stress the battery pack) such as when climbing a steep hill or during fast motorway driving.

Table 1 below illustrates these various example operational modes:

TABLE 1
Example range extender operational modes

| State of Charge/ | Range Extender operation | |
|---|---|---|
| Discharge | High speeds | Low speeds |
| High current threshold | On - high power | NA |
| exceeded | | |
| SOC < target level | On - high efficiency | On - low power |
| SOC << target level | On - high power | On - lower power |
| SOC > target level | Off | Off |

The above description primarily identifies operational points with low noise, high efficiency and high power, however any point between these operational points may be used. Typical values for these would be over 90% efficiency of the electric machine 210 and over 90% volumetric efficiency of the internal combustion engine 220, these combine to give the option of power on demand—which may be useful in non-charge sustaining mode. Additionally, a low rpm start mode may be introduced to effectively give a soft start/warm up phase of the range extender 200. The electric machine 210 is used to start the range extender 200, initially increasing the rpm from zero to the rpm of the low rpm start mode. In addition to normal telematics packages, some or all may be provided in a handheld package such as an iPhone®, iPad® or Android® device (with or without additional hardware).

As the range extender 200 is changed from a first operational point to a second operational point by the controller 230, the rpm of the internal combustion engine 220 is increased or decreased smoothly to the rpm of the second operational point. This period over which the rpm is changing is referred to as a transient phase. Where the engine 220 experiences a constant load, e.g. the load of the electric machine 210, the controller 230 may achieve an increasing rpm by increasing the fuel injection rate into the engine 220.

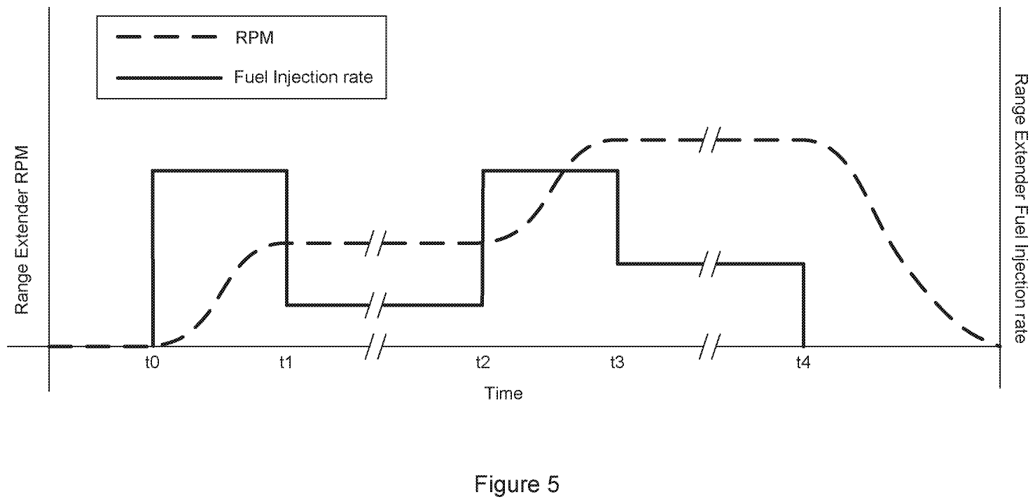

With reference to FIG. 5, a graph is shown which depicts the operation of an internal combustion engine in a conventional range extender. The graph shows the engine speed or rpm of the range extender engine over time, and the rate at which fuel is injected. The graph is indicative of a conventional operation only and is not to scale. The range extender is initially turned off, that is, the vehicle is operating in a pure-EV mode or is stationary.

At a time t0, the range extender is controlled to turn on and run at a first operational point, for example a low power mode. The engine is turned on at to and fuel is injected into the engine at a rate set by the controller. Between t0 and t1 the engine is accelerated until the rpm reaches the rpm of the first operational point i.e. up to 1000 rpm to reach the low power mode. The controller controls the electric machine to remove any load from the engine and controls fuelling of the engine at a sufficiently high rate to accelerate the engine. The period between t0 and t1 is a transient phase, the rate of fuel injection is controlled by the controller and determines the length of the transient phase.

At time t1, the rpm of the engine reaches the rpm of the first operational point. While the range extender operates at the first operational point, the electric machine applies a load to the engine and generates power, and the fuel injection rate is maintained at a constant rate which is sufficient to maintain the rpm of the first operational point. The fuel injection rate of the transient phase t0 to t1 may be the same at that of the first operation point, however, the engine will accelerate slowly to the rpm of the first operational point and the transient phase will be long. Therefore the fuel injection rate of the transient phase is typically larger, in order to reduce the length of the transient phase, as shown in FIG. 4.

In the same way, a higher fuel rate is used to accelerate the engine to a higher operational point, for example, the high efficiency mode. The engine may be operated at the first operation point for an extended period of time e.g. several minutes or several hours before the high efficiency mode is required. Therefore T1 and T2 may be close together or may be separated by a substantial period of time.

At point t2, the range extender is controlled to move to a second operational point which is the high efficiency mode. In a transient phase between t2 and t3 the controller controls the electric machine to remove the load from the engine, and the engine is accelerated by a higher fuel injection rate until the rpm of the engine reaches the rpm of the second operational point i.e. up to 1500 rpm for the high efficiency mode. At t3, the controller controls the electric machine to apply a load to the engine and generate power, and fuels the engine at a constant rate which is sufficient to maintain the rpm of the second operational point.

Between t3 and t4 the range extender operates at the second operational point. The engine may be operated at the second operation point for an extended period of time e.g. several minutes or several hours until, at t4, the range extender is controlled to turn off. Therefore t3 and t4 may be close together or may be separated by a substantial period of time. At t4, the range extender is turned off and the rpm drops to zero as no fuel is injected into the engine and the engine is decelerated by the load of the electric machine.

According to the conventional operation of the range extender, the fuel injection rate is increased during the transient phases, to reduce the time taken to move from one operational mode to another.

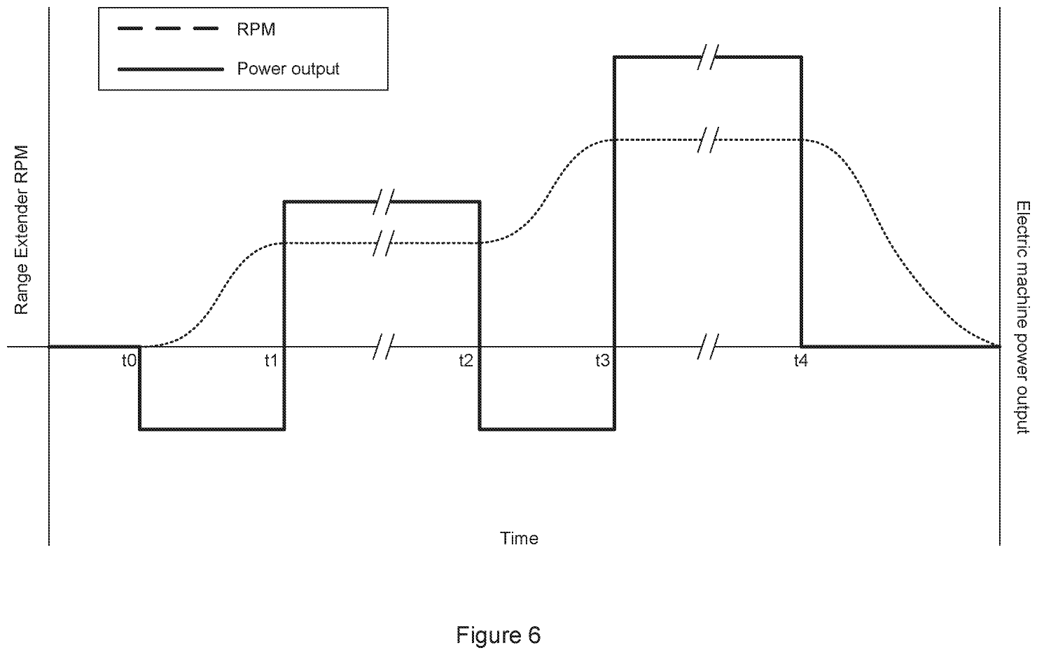

With reference to FIG. 6, a graph is shown which depicts the operation of an electric machine 210 in a range extender 200 according to an embodiment. The graph shows the engine speed or rpm of the engine 220 over time, and the power output of the electric machine 210 to the battery 106. A positive output from the electric machine 210 charges the battery 106, while a negative power output represents the supply of power from the battery 106 to the electric machine 210 to drive the electric machine 210. An electric machine may be operated as a generator or motor and may be referred to as an e-machine. The graph is indicative of the range extender 200 operation and is not drawn to scale.

Initially, the range extender 200 is turned off, that is, the vehicle is operating in a pure-EV mode or is stationary. The engine 220 of the range extender 200 is turned off and no power is output by the electric machine 210 to the battery 106. At to, the range extender 200 is controlled to turn on and run at a first operational point, for example a low power mode.

To increase the rpm of the engine 220, power is supplied to the electric machine 210 by the battery 106. The controller 230 controls the electric machine 210 to act as a motor and drive the engine 220, so that the engine 220 is accelerated using power stored in the battery 106. Between t0 and t1 the engine 220 is accelerated by the electric machine 210 until the rpm reaches the rpm of the first operational point i.e. up to 1000 rpm for the low power mode. The period between t0 and t1 is a transient phase, and the length of the transient phase is determined by the amount of power supplied to the electric machine 210 by the battery 106.

At the first operational point the controller controls the electric machine to apply a load to the engine 220 and generate power, and controls fuelling of the engine 220 a rate which is sufficient to maintain the rpm of the first operational point. Between t1 and t2, the range extender 200 operates at the first operational point and the fuel injection rate is constant. The engine 220 of the range extender 200 drives the electric machine 210 and power is output from the electric machine 210 to the battery 106. As above, t1 and t2 may be close together in time or may be separated, depending on the period of time for which the range extender 200 remains in the first operational mode.

At point t2, the range extender 200 is controlled to move to a second operational point, is for example the high efficiency mode. In a transient phase between t2 and t3 the engine 220 is accelerated by supplying power to the electric machine 210. The electric machine 210 is controlled to remove the load from the engine 220 and instead drive the engine 220 until the rpm reaches the rpm of the second operational point i.e. 1500 rpm for the high efficiency mode.

At t3, the controller 230 controls the electric machine 210 to stop driving the engine 220 and to apply a load to generate power. The controller 230 controls fuel injection of the engine 220 at a rate which is sufficient to maintain the rpm of the second operational point. The engine 220 drives the electric machine 210 between t3 and t4 and generates power. The range extender 200 operates at the second operational point, which has a higher rpm than the first operational point, and so a greater level of power is output to the battery 106. The range extender 200 may remain in the second operation mode for a period of time, and so t3 and t4 may be close together or separated by several minutes or hours. At t4, the range extender 200 is controlled to turn off, the controller 230 stops fuelling the engine 220 and the load of the electric machine 210 decelerates the rpm of the engine 220 down to zero.

According to the embodiment, the electric machine 210 is supplied with power to drive the engine 220 during the transient phases, in order to accelerate the engine 220 from one operational mode to another. At each operational point, the engine 220 is driven by fuelling at a constant rate, and the engine 220 drives the electric machine 210 to output power and charge the battery 106.

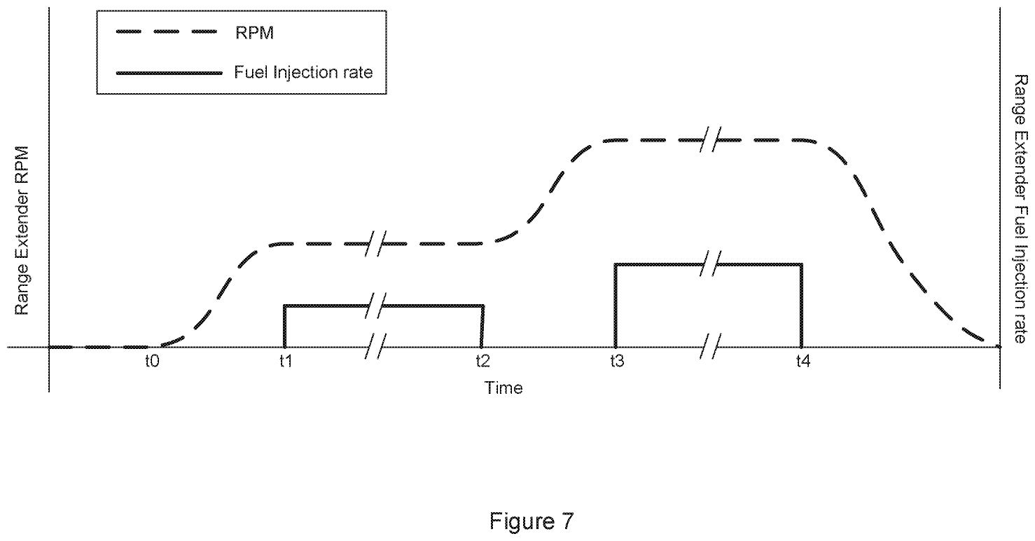

With reference to FIG. 7, a graph is shown which depicts the operation of the internal combustion engine 220 in the range extender 200 of the embodiment. The graph shows the rate at which fuel is injected, in comparison with the rpm of the range extender 200 engine 220 over time.

In each of the transient periods, from t0 to t1 and from t2 to t3, the engine 220 is driven by the electric machine 210 and no fuel is injected into the engine 220. Once the engine rpm reaches the rpm of the set operational point, that is, the rpm of the low power mode at t1 and the rpm of the high efficiency mode at t3, then fuel is injected at a constant rate to sustain the operational point.

The range extender 200 provided uses the electric machine 210 to accelerate the internal combustion engine 220 to a higher operational point. No fuel is injected into the engine 220 of the range extender 200 in the transient periods and therefore there are no emissions during the transient periods. The range extender 200 does not exhibit the high fuel consumption associated with the high fuel injection rates conventionally used in transient periods. The range extender 200 avoids the high levels of emissions associated with the high fuel injection rates conventionally used in transient periods.

Furthermore, the engine 220 in the range extender 200 is configured to operate at a static rpm only. The engine 220 operates at one or more set operation points having a fixed rpm. The range extender 200 therefore has a predictable fixed level of emissions for each mode of operation, and can be subjected to regulatory tests for emissions for the set modes only.

The engine 220 of the range extender 200 can be tuned specifically to ensure high performance and/or high efficiency at one or more operation points only, without the need to consider performance or efficiency in the transient periods. For example, fuel mapping is much simpler to develop, as part load values are not critical.

It will be understood that the present invention has been described above purely by way of example, and modifications of detail can be made within the scope of the invention.

Reference numerals appearing in the claims are by way of illustration only and shall have no limiting effect on the scope of the claims.

1. A range extender (200) for a vehicle, comprising:
an electric machine (210);
an engine (220); and
a controller (230), wherein the controller is configured to control fuelling of the engine, and is configured to control the electric machine to charge a battery of the vehicle using power from the engine and at other times to control the electric machine to drive the engine using power from the battery,
wherein the controller is configured to increase the engine speed by controlling the electric machine to drive the engine using power from the battery whilst substantially not fuelling the engine.

2. The range extender of claim 1, wherein the controller is configured to control is the electric machine to drive the engine to increase the engine speed to an operational point set by the controller.

3. The range extender of claim 2, wherein the controller is configured to begin fuelling the engine when the operational point is reached.

4. The range extender of claim 2 or claim 3, wherein the controller is configured to fuel the engine at a constant fuel injection rate at the operational point.

5. The range extender of any one of claims 2 to 4, wherein the controller controls the electric machine charge the battery of the vehicle at the operational point, using power from the engine.

6. The range extender of any one of claims 2 to 5, wherein the controller is configured to set an operational point out selected from two or more stored operational points.

7. The range extender of claim 6, wherein the two or more operational points correspond at least to a high efficiency mode and a high power mode.

8. The range extender of any preceding claim, wherein the controller is configured to increase the engine speed from a first operational point set by the controller to a second operational point set by the controller by controlling the electric machine to drive the engine using power from the battery whilst substantially not fuelling the engine.

9. A vehicle (100) comprising:
an electric motor (108) arrange to propel the vehicle;
a battery (106) for providing power to the electric motor; and
the range extender (100) according to any preceding claim.

10. The vehicle of claim 9, wherein the electric machine of the range extender is controlled by the controller of the range extender to provide power to the electric motor.
